(19) United States
(12) Patent Application Publication
(10) Pub. No.: US 2020/0139167 A1
(43) Pub. Date: May 7, 2020

(54) FIRE BARRIER APPARATUS

(71) Applicant: Mark David GROBEN, London (GB)

(72) Inventor: Mark David GROBEN, London (GB)

(21) Appl. No.: 16/627,084

(22) PCT Filed: Jun. 26, 2018
(86) PCT No.: PCT/GB2018/051780

§ 371 Date: Dec. 27, 2019

(30) Foreign Application Priority Data
Jun. 27, 2017 (GB) 1710254.2

(51) Int. Cl. A62C 2/06; A62C 3/02

(52) U.S. Cl. CPC A62C 2/06; A62C 3/0257

(57) ABSTRACT

A fire barrier apparatus comprises a plurality of elongate, hollow barrier members. Each barrier member defines an interior, an inlet arrangement, through which, in use, air can enter the interior and an outlet arrangement, through which, in use, air can exit from the interior. The apparatus is arranged so that each barrier member abuts at least one adjacent barrier member.

### BACKGROUND OF THE INVENTION

### 1. Field of the Invention

The present invention relates to fire barrier apparatus.

### 2. The Prior Art

Wildfires are a feature of hot, dry seasons in many countries. However, population increase and climate change means that such wildfires pose an increasing threat to human life and habitation. Typically, defences against wildfires include cleared areas to form fire breaks. Conventionally, fire barrier apparatus can be erected to slow or prevent the spread of fire and may be comprised of relatively low flammability or heat resistant materials such as steel, concrete, masonry, ceramic etc. However, such fire barrier apparatus is relatively expensive and only partially effective in many cases.

### SUMMARY OF THE INVENTION

According to a first aspect of the present invention, there is provided fire barrier apparatus, the apparatus comprising a plurality of elongate, hollow barrier members, each barrier member defining an interior, an inlet arrangement, through which, in use, air can enter the interior and an outlet arrangement, through which, in use, air can exit from the interior, the apparatus being arranged so that each barrier member abuts at least one adjacent barrier member.

In this specification, the word “abuts” has the ordinary English meaning of “locates against and is in contact with”.

Possibly, the inlet arrangement is located at or towards a lower end in use of the barrier members. Possibly, the outlet arrangement is located at or towards an upper end in use of the barrier members.

Possibly, in use, the inlet arrangement permits air to enter the interior from a hot side of the apparatus, ie the side on which a fire is located.

Possibly, in use, the inlet arrangement permits air to enter the interior from both the hot side and a cold side, ie the side opposite to that on which the fire is located.

Possibly, each barrier member includes a wall, which includes an external surface. Possibly, each wall defines the interior of the respective barrier member. Possibly, the wall of each barrier member defines a plurality of through holes and may define an array of through holes. Possibly, the array extends substantially over a greater part of the wall surface.

Possibly, at least some of the holes of the array comprise the inlet arrangement.

Possibly, some of the holes of the array comprise the outlet arrangement.

Possibly, each barrier member extends along a longitudinal axis, which, in an installed condition, may extend generally upwardly.

Possibly, the barrier members are arranged in a single row, and may be arranged substantially in a line.

Possibly, the barrier members are arranged in a plurality of rows. Possibly, the barrier members of one row locate partially into interstitial spaces defined between the barrier members of an adjacent row. Possibly, the barrier members of one row abut two barrier members of an adjacent row.

Possibly, each barrier member defines an end opening at an in use upper end. Possibly, the end opening comprises the outlet arrangement.

Possibly, each barrier member is in the form of a cylindrical hollow tube which, in the uninstalled condition, is open at both ends.

Possibly, in the installed condition, each barrier member is closed at its in use lower end, possibly by the ground.

Possibly, each barrier member is substantially circular or polygonal in cross section shape and has a maximum cross section dimension, which may be a diameter or a diagonal and may be an internal dimension or an external dimension. Desirably, each barrier member is substantially circular in cross section shape.

Possibly, the barrier members are of similar maximum cross section dimension.

Possibly, the maximum cross-section dimension is no more than 100 mm and may be no more than 70 mm.

Possibly, each array hole is substantially circular or polygonal in shape and has a maximum opening dimension, which may be a diameter or a diagonal. Possibly, all of the holes of the array are of similar maximum opening dimension.

Possibly, the maximum opening dimension of the holes of the array is no more than 40 mm and may be no more than 35 mm.

Possibly, for each barrier member, the array of holes provides a total open area, which is the sum of the areas of all of the array holes. Possibly, for each barrier member, the total open area is a proportion of the total area of the wall surface. Possibly, the proportion is at least 10%. Possibly, the proportion is no more than 95%.

Possibly, each barrier member is formed of a metal material and may be formed of a steel, which may be aluminium, stainless steel or galvanised mild steel. Possibly, the metal material is unpainted.

Possibly, each barrier member is formed of a meshed or perforated material. Possibly, the meshed or perforated material comprises a plurality of wire members, which may be welded, fastened, knitted or woven together in criss-cross fashion.

Possibly, the meshed or perforated material is formed from a sheet of material, which may be perforated, possibly by drilling, pressing, stamping or die cutting.

Possibly, the wall of each barrier member includes surface areas over which the array extends, and one or more solid areas, over which the array does not extend. Possibly, the solid area(s) is located at or towards the in use upper end of the barrier member.

According to a second aspect of the present invention, there is provided a method of preventing the spread of fire, the method comprising providing fire barrier apparatus, the apparatus comprising a plurality of elongate, hollow barrier members, each barrier member defining an interior, an inlet arrangement, through which, in use, air can enter the interior and an outlet arrangement, through which, in use, air can exit from the interior, the apparatus being arranged so that each barrier member abuts at least one adjacent barrier member.

Possibly, the apparatus includes any of the features described in any of the preceding statements or following description. Possibly, the method includes any of the steps described in any of the preceding statements or following description.

### BRIEF DESCRIPTION OF THE DRAWINGS

Embodiments of the present invention will now be described, by way of example only, and with reference to the accompanying drawings, in which:

FIG. 1 is a perspective view of a first fire barrier apparatus;

FIG. 2 is a plan view from above of the apparatus of FIG. 1;

FIG. 3 is a front view of the apparatus of FIGS. 1 and 2;

FIG. 4 is a relatively enlarged detail view of part of the first fire barrier apparatus as indicated in FIG. 3;

FIG. 5 is a perspective view of a second fire barrier apparatus;

FIG. 6 is a plan view from above of the apparatus of FIG. 5;

FIG. 7 is a front view of the apparatus of FIGS. 5 and 6;

FIG. 8 is a perspective view of a third barrier apparatus;

FIG. 9 is a relatively enlarged detail view of part of the third fire barrier apparatus as indicated in FIG. 8;

FIG. 10 is a side cross-sectional schematic view of the first fire barrier assembly in an in-use condition; and

FIG. 11 is a side cross-sectional schematic view of the second fire barrier assembly in an in-use condition.

### DETAILED DESCRIPTION OF THE PREFERRED EMBODIMENTS

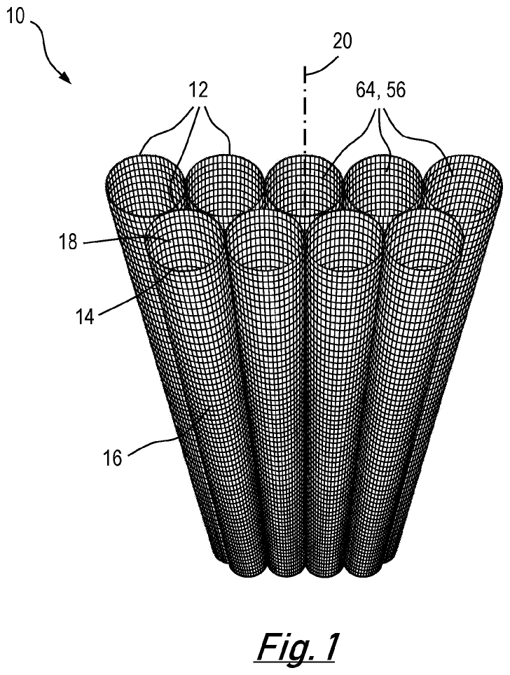

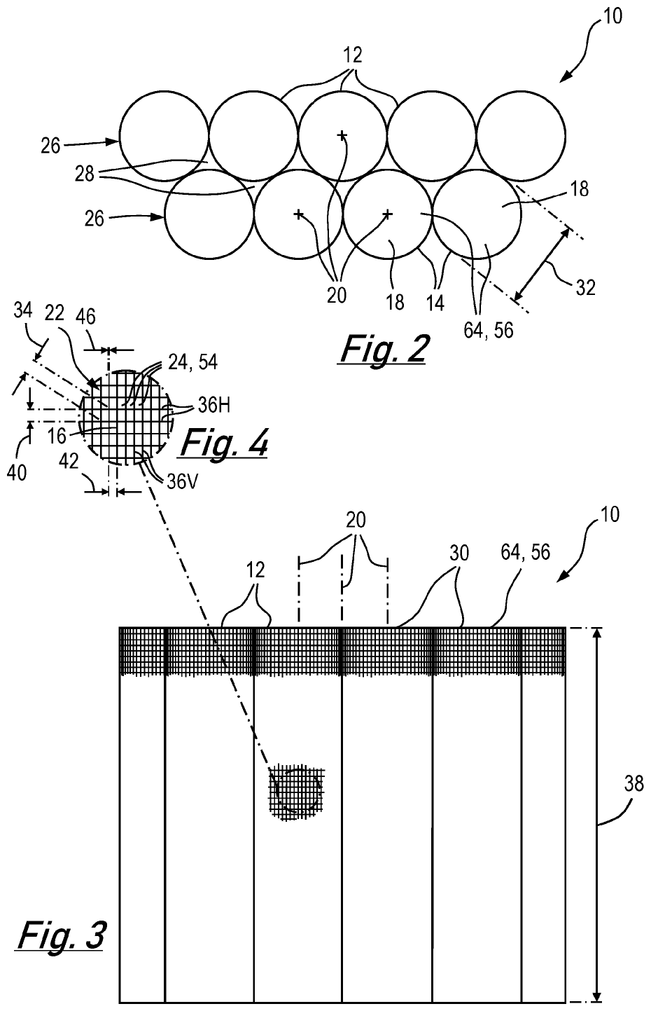

FIGS. 1 to 4 and 10 show a fire barrier apparatus 10. The apparatus 10 comprises a plurality of elongate, hollow barrier members 12. Each barrier member 12 defines an interior 18, an inlet arrangement 54, through which, in use, air can enter the interior 18 and an outlet arrangement 56, through which, in use, air can exit from the interior 18. The apparatus 10 is arranged so that each barrier member 12 abuts at least one adjacent barrier member 12.

Each barrier member 12 includes a wall 14 which includes an external surface 16. Each wall 14 defines the interior 18 of the respective barrier member 12. Each barrier member 12 extends along a longitudinal axis 20, which, in an installed condition, extends generally upwardly.

The wall 14 of each barrier member 12 defines an array 22 of through holes 24, the array 22 extending substantially over a greater part of the wall surface 16. In this example, the holes 24 comprise the inlet arrangement 54.

In the example shown in FIGS. 1 to 4 and 10, the barrier members 12 are arranged in two rows 26, each row 26 being a line of adjacent, abutting barrier members 12. The barrier members 12 of one row 26 locate partially into interstitial spaces 28 defined between the barrier members 12 of an adjacent row 26, so that each of the barrier members 12 of one row 26 abut two barrier members 12 of the adjacent row 26 (excepting the endmost barrier members 12), and two adjacent barrier members 12 of the same one row 26 (excepting, again, the endmost barrier members 12).

Each barrier member 12 defines an end opening 64 at an in use upper end 30. In this example, the end opening 64 comprises the outlet arrangement 56.

In an uninstalled condition, each barrier member 12 is open at both ends. Thus, in this example, each barrier member 12 is in the form of a cylindrical hollow tube which, in the uninstalled condition, is open at both ends.

In the example shown in FIGS. 1 to 4 and 10, each barrier member 12 is substantially circular in cross section shape and has a maximum cross section dimension 32, which is an external diameter.

The barrier members 12 of the apparatus 10 are of similar maximum cross section dimension 32.

The maximum cross-section dimension 32 could be no more than 100 mm and desirably is no more than 70 mm.

In the example shown in FIGS. 1 to 4 and 10, each array hole 24 is substantially rectangular in shape, having a height 40 and a width 42, and having a maximum opening dimension 34, which is a diagonal. All of the holes 24 of the array 22 are of similar maximum opening dimension 34.

The maximum opening dimension 34 could be no more than 40 mm and desirably is no more than 35 mm.

For each barrier member 12, the array 22 of holes 24 provides a total open area, which is the sum of all the areas of all of the array holes 24 and is a proportion of the total area of the wall surface 16. The proportion could be at least 10%. The proportion could be no more than 95%.

Each barrier member 12 is formed of an unpainted metal material and could be formed of a steel, which could be stainless steel or galvanised mild steel. In other examples, the barrier members 12 could be formed of aluminium.

As shown in FIGS. 3 and 4, each barrier member 12 could be formed of a meshed or perforated material, which could comprise a plurality of wire members 36, comprising in-use vertical wire members 36V and in use horizontal wire members 36H, which are welded, fastened, knitted or woven together in criss-cross fashion.

The barrier members 12 have a height 38. In general, the higher the barrier members 12, the better, to avoid carry over of fire over the top of the barrier members 12. In practice, the height 38 is limited by practical considerations and for example, could be in the range 700 mm to 3000 mm.

In use, in one example, as shown in FIG. 10, the barrier members 12 are installed so that one end is closed by the ground 48, being either in the ground 48 or on the ground surface. If the ground conditions permit, the barrier members 12 could be partially buried in the ground, so that the ground provides support to keep the longitudinal axes 20 substantially vertical. Otherwise, or in addition, supporting members (not shown) or a supporting structure (not shown) could be provided, to which the barrier members 12 are fixed.

The functioning of the fire barrier assembly 10 in use is discussed further below.

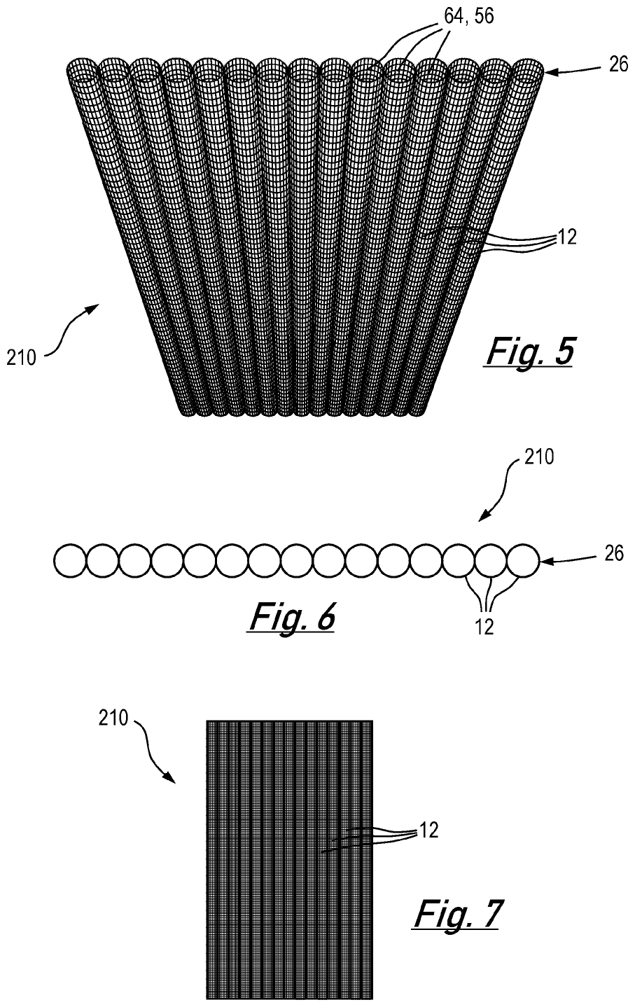

FIGS. 5 to 9 and 11 show other embodiments of the invention, many features of which are similar to those already described in relation to the embodiment of FIGS. 1 to 4 and 10. Therefore, for the sake of brevity, the following embodiments will only be described in so far as they differ from the embodiment already described. Where features are the same or similar, the same reference numerals have been used and the features will not be described again.

FIGS. 5 to 7 and 11 show a second fire barrier assembly 210. In this example, the barrier members 12 are arranged substantially in a line in a single row 26. In this example, the barrier members 12 are formed of substantially the same material as the first fire barrier assembly 10 described above.

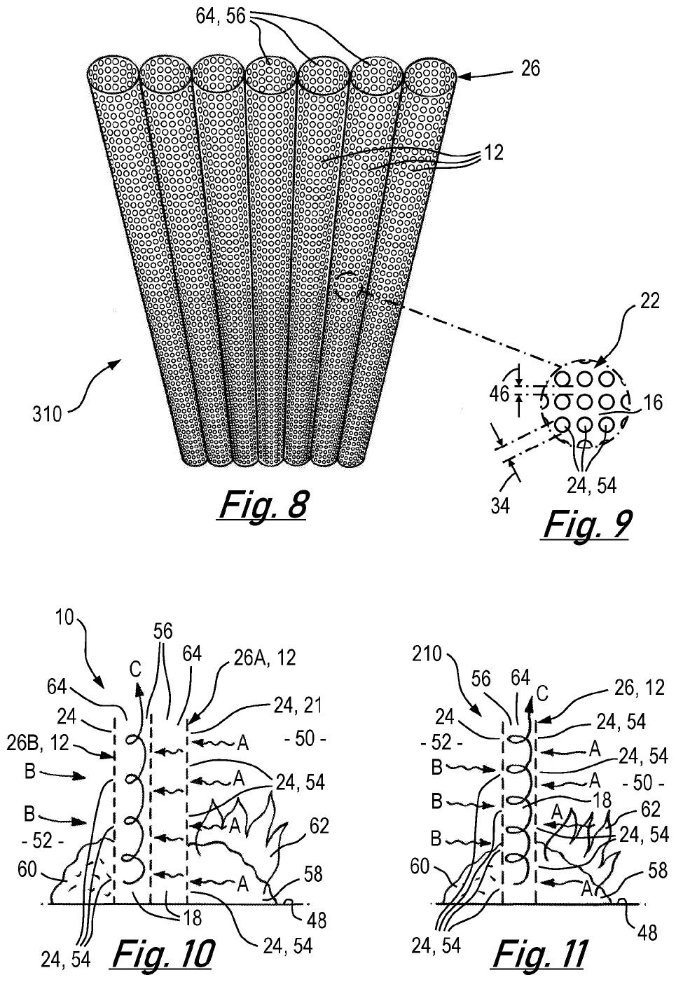

FIGS. 8 and 9 show a third fire barrier assembly 310, in which the barrier members 12 are again arranged substantially in a line in a single row 26. In this example, each barrier member 12 is formed of a perforated material, for example, from a sheet of material which has been perforated, for example, by drilling, pressing, stamping or die cutting. The array holes 24 in this example are circular.

The applicant has tested a number of examples of fire barrier assemblies in experiments to identify the design parameters which determine the effectiveness of use as a fire barrier. The experiments undertaken and the results are summarised in Table 1 and observations given below. FIGS. 10 and 11 show in general the arrangement of single row and double row fire barrier assemblies in the experiments.

Table 1 includes a dimension “Spacing between array holes 46” shown in FIGS. 4 and 9, which equates to the thickness of the material between the holes 24, eg the wire gauge. In each experiment, a first amount 58 of combustible material was set on fire against one side (designated the “hot side 50”) of the fire barrier being tested, with a second amount 60 of combustible material located on the other side (designated the “cold side 52”), and the ability of the fire barrier to prevent the spread of the fire to the second amount 60 of combustible material was observed.

TABLE 1
Summary of Experimental Results

| | | | | Maximum | | | | | | | | |
|---|---|---|---|---|---|---|---|---|---|---|---|---|
| | | | | cross | | | | Array | | Open | | |
| | | | | section | | | | hole | Spacing | area % | | |
| | | | Cross | dimension | | Array | Array | max | between | of array | No of | |
| | | Height 38 | section | 32 (mm) of | | hole | hole | opening | array | holes | rows 26 | |
| | Material of | of barrier | shape of | barrier | Array | height | width | dimension | holes | 24/wall | of barrier | |
| Exper- | barrier | member 12 | barrier | member | hole | 40 | 42 | 34 | 46 | surface | members | Effec- |
| iment | member 12 | (mm) | member 12 | interior 18 | shape | (mm) | (mm) | (mm) | (mm) | 16 | 12 | tive? |
| 1 | Galvanised | 620 | Circular | 50 | Square | 25 | 25 | 35.4 | 1.0 | 92.5 | 2 | Yes |
| | steel | | | | | | | | | | | |
| 2 | Galvanised | 600 | Circular | 300 | Square | 6 | 6 | 8.5 | 1.0 | 73.5 | 1 | No |
| | steel | | | | | | | | | | | |
| 3 | Stainless | 720 | Circular | 22 | Square | 3 | 3 | 4.2 | 0.80 | 62.3 | 1 | Yes |
| | steel | | | | | | | | | | | |
| 4 | Galvanised | 900 | Circular | 55 | Square | 13 | 13 | 18.4 | 0.9 | 87.5 | 1 | No |
| | steel | | | | | | | | | | | |
| 5 | Galvanised | 900 | Circular | 55 | Square | 13 | 13 | 18.4 | 0.9 | 87.5 | 2 | Yes |
| | steel | | | | | | | | | | | |
| 6 | Galvanised | 900 | Square | 70.7 | Square | 13 | 13 | 18.4 | 0.9 | 87.5 | 2 | No |
| | steel | | (50 × 50) | | | | | | | | | |
| 7 | Galvanised | 900 | Square | 70.7 | Square | 13 | 13 | 18.4 | 0.9 | 87.5 | 1 | No |
| | steel | | (50 × 50) | | | | | | | | | |
| 8 | Galvanised | 900 | Circular | 140 | Square | 13 | 13 | 18.4 | 0.9 | 87.5 | 1 | No |
| | steel | | | | | | | | | | | |

### Experiment 1

In this experiment, the barrier members 12 were provided in the form of the first fire barrier assembly 10 shown in FIG. 10, comprising two rows 26A, 26B of cylindrical open ended tubes of a meshed material. Hot air as shown by arrows A and naked flames 62 managed to pass through the first row 26A but did not progress past the second row 26B. Observed occasional vertical spiraling of flame in second row 26B of barrier members 12. No ignition of combustible material 60 resting directly against the rear of the second row 26A.

### Experiment 2

In this experiment, the barrier members 12 were provided in the form of the second fire barrier assembly 210, comprising one row 26 of cylindrical open ended tubes of a meshed material. Fire passed through the barrier members 12 to ignite the second amount 60 of combustible material behind the fire barrier assembly 210.

### Experiment 3

In this experiment, the barrier members 12 were provided in the form of the second fire barrier assembly 210, comprising one row 26 of cylindrical open ended tubes of a meshed material. There was no passage of fire through the fire barrier assembly 210 and the second amount 60 of combustible material remained unlit.

### Experiment 4

In this experiment, the barrier members 12 were provided in the form of the second fire barrier assembly 210, comprising one row 26 of cylindrical open ended tubes of a meshed material. Ignition of the second amount 60 of combustible material occurred.

### Experiment 5

In this experiment, the barrier members 12 were provided in the form of the second fire barrier assembly 210, comprising one row 26 of cylindrical open ended tubes of a meshed material. No ignition of the second amount 60 of combustible material occurred.

### Experiment 6

In this experiment, a fourth fire barrier assembly (not shown) comprised two rows of barrier members 12 in the form of square section open ended tubes of a meshed material. Ignition of the second amount 60 of combustible material occurred.

### Experiment 7

In this experiment, a fifth fire barrier assembly (not shown) comprised one row of barrier members 12 in the form of square section open ended tubes of a meshed material. Ignition of the second amount 60 of combustible material occurred.

### Experiment 8

In this experiment, the barrier members 12 were provided in the form of the second fire barrier assembly 210, comprising one row 26 of cylindrical open ended tubes of a meshed material. Fire progressed easily though the barrier members to ignite the second amount 60 of combustible material.

In broad terms, these experiments appear to show that:
increasing the number of rows increases the effectiveness for a given array hole size and open area proportion;
circular cross section barrier members 12 are more effective than square section barrier members 12;
as the maximum cross section dimension 32 increases above 55 mm, effectiveness decreases;
a smaller array hole maximum opening dimension and open area proportion is more effective;
a single row of barrier members might be sufficient where the open area proportion is approximately 65% and lower;
at least two rows of columns will be required for an open area proportion greater than 65% and less than 95%.

The applicant initially took inspiration from the use of wire gauze to contain flame in mining safety lamps. Clearly, however, wire gauze is impractical for use in large scale flame barriers. The above results show that the principle of flame containment by a meshed or perforated metal material appears to operate at a larger scale. However, the applicant has surprisingly found from observation that one or more other effects in addition to the screening effect of mesh may be involved, namely a chimney effect, a vortex effect and a heat sink effect.

The applicant believes that the cylindrical tube-like shape of the barrier members is important and has observed the formation of upwardly moving vortices of hot smoky air within the interiors 18 during the successful experiments. Square section barrier members 12 may be less effective because they are less conducive to vortex formation. Similarly, large diameter cross section barrier members 12 may be less effective because they do not induce vortex formation.

The applicant believes that an open area of 92.5% is getting close to the limit of effectiveness for the invention and that practically a figure of 95% provides an upper limit for the open area proportion. As the open area proportion increases, there is less resistance to through air flow and less chance for vortices to form.

The applicant believes that as the flames 62 approach the fire barrier assembly 10, 210, the flames 62 will cause movement of hot air (arrow A) from the hot side 50 and cooler air (arrow B) from the cold side 52 towards the barrier members and into the interior 18. As the hot and cold air from opposite sides of the barrier member meet, a vortex forms which moves upwardly as shown by arrow C. A chimney effect is then formed in which the upwardly moving air and the vortex formation suck in more air and eject it upwards, so that each of the barrier members effectively becomes a small chimney. The mixing of the hot air and the cooler air serves to cool the barrier members. Furthermore, the heat from the hot side will in general be dissipated throughout the metal structure of the apparatus and therefore reduce the risk of the fire progressing through the barrier members or reaching a temperature above auto-ignition of the combustible material.

Thus, the fire barrier assembly prevents the passage of both heat and flame across the assembly.

The results above appear to show that with the larger mesh sizes and open area proportions an additional row of barrier members is required, with the front row 26A acting to reduce air velocity to enable the second row of barrier members to generate the vortices, as shown in FIG. 10.

Another way of describing the above is that the first row of barrier members acts as a diffuser to reduce the velocity and increase the static pressure of the air flow. In the case when the air velocity is sufficiently low, then vortices can form in the first row. However, as the airflow increases to the point that vortices cannot form in the first row, the first row acts as a diffuser to slow the air velocity entering the second row of barrier members where vortices can then form.

Due to the effects of turbulence, as a general rule the greater the open area the less resistance there will be to the velocity of the air passing through the mesh. A mesh with a much lower open area will increase resistance to the air flow (increasing pressure on the mesh) and reduce the velocity of the air passing through.

Various other modifications could be made without departing from the scope of the invention. The fire barrier assembly and the barrier members could be of any suitable size and shape, and could be formed of any suitable material (within the scope of the specific definitions herein).

For example, the barrier members could be different in cross section shape, eg polygonal. The maximum cross section dimension 32 could be a diameter or a diagonal, and could be an internal dimension or an external dimension.

Each array hole could be polygonal in shape and the maximum opening dimension 34 could be a diameter or a diagonal.

In one example, some of the holes of the array could comprise the outlet arrangement.

In one example, the wall of each barrier member could include surface areas over which the array extends, and one or more solid areas (not shown), over which the array does not extend. The solid area(s) is located at or towards the in use upper end of the barrier member.

Adjacent barrier members could be fixed together and/or to a support by any convenient means, such as, for example, welding, using fasteners such as bolts, screws, or rivets, or by clips.

Any of the features or steps of any of the embodiments shown or described could be combined in any suitable way, within the scope of the overall disclosure of this document.

There is thus provided fire barrier assemblies with a number of advantages over conventional arrangements. In particular, the fire barrier assemblies can be very quickly erected as required, for example, in a wildfire situation. The barrier members are of simple construction and formed of standard readily available materials. Advantageously, following use the barrier members can be easily uninstalled and kept for reuse, refurbishment or recycling.

The fire barrier assemblies of the invention could also be used in other situations such as within buildings, industrial sites and built up areas to provide fire barriers.

What is claimed is:

1. A fire barrier apparatus comprising:
a plurality of elongate, hollow barrier members, each barrier member comprising:
an interior,
an inlet arrangement, through which, in use, air can enter the interior, and
an outlet arrangement, through which, in use, air can exit from the interior,
the apparatus being arranged so that each barrier member abuts at least one adjacent barrier member.

2-3. (canceled)

4. The apparatus according to claim 1, in which, in use, the barrier members are oriented with the outlet arrangement at an upper end thereof and the inlet arrangement at a lower end thereof to permit air to enter the interior from a hot side of the apparatus where a fire is located.

5. The apparatus according to claim 1, in which, in use, the inlet arrangement permits air to enter the interior from both the hot side where a fire is located and a cold side.

6. The apparatus according to claim 1, wherein each barrier member includes a wall bordering the interior of the respective barrier member and an external surface, wherein a plurality of through holes are formed in the wall.

7-8. (canceled)

9. The apparatus according to claim 6, in which the wall of each barrier member includes an array of through holes.

10. The apparatus according to claim 9, in which the array extends substantially over a greater part of the wall surface.

11. The apparatus according to claim 9, in which at least some of the holes of the array comprise the inlet arrangement.

12. The apparatus according to claim 9, in which some of the holes of the array comprise the outlet arrangement.

13. (canceled)

14. The apparatus according to claim 1, in which the barrier members are arranged in a single row.

15. (canceled)

16. The apparatus according to claim 1, in which the barrier members are arranged in a plurality of rows.

17. The apparatus according to claim 16, in which the barrier members of one row locate partially into interstitial spaces defined between the barrier members of an adjacent row, and wherein each barrier member abuts two barrier members of the adjacent row.

18-20. (canceled)

21. The apparatus according to claim 4, in which each barrier member is in the form of a cylindrical hollow tube which, in the uninstalled condition, is open at both ends, with the lower end adapted to be closed by the ground.

22. (canceled)

23. The apparatus according to claim 1, in which each barrier member is one of circular or polygonal in cross section shape and has a maximum cross section dimension.

24. (canceled)

25. The apparatus according to claim 23, in which the barrier members are of similar maximum cross section dimension.

26. The apparatus according to claim 25, in which the maximum external cross-section dimension is no more than 100 mm.

27-28. (canceled)

29. The apparatus according to claim 26, in which the maximum opening dimension of the holes of the array is no more than 40 mm.

30. The apparatus according to claim 9, in which, for each barrier member, the array of holes provides a total open area, which is the sum of the areas of all of the array holes, and, in which, for each barrier member, the proportion of the total open area to the total area of the wall surface is between 10% and 95%.

31. The apparatus according to claim 30, in which each barrier member is formed of a metal selected from the group consisting of steel, aluminum, stainless steel or galvanized mild steel.

32. The apparatus according to claim 31, in which each barrier member is formed from one of a meshed or perforated material.

33-34. (canceled)

35. The apparatus according to claim 9, in which the wall of each barrier member includes surface areas over which the array extends, and one or more solid areas, over which the array does not extend, wherein the solid area is located near the upper end of the barrier member.

36-38. (canceled)
